(19) United States
(12) Patent Application Publication
(10) Pub. No.: US 2017/0207548 A1
(43) Pub. Date: Jul. 20, 2017

(54) MULTI-BAND MONOPOLE PLANAR ANTENNAS CONFIGURED TO FACILITATE IMPROVED RADIO FREQUENCY (RF) ISOLATION IN MULTIPLE-INPUT MULTIPLE-OUTPUT (MIMO) ANTENNA ARRANGEMENT

(71) Applicant: Corning Optical Communications Wireless Ltd, Airport City (IL)

(72) Inventors: Ronen Schwartzman, Rehovot (IL); Yuval Tzur, Kochav Yair (IL)

(21) Appl. No.: 15/473,977

(22) Filed: Mar. 30, 2017

Related U.S. Application Data
(63) Continuation of application No. PCT/IL2015/051061, filed on Oct. 29, 2015.
(60) Provisional application No. 62/074,293, filed on Nov. 3, 2014.

(51) Int. Cl. H01Q 21/24; H01Q 1/52; H01Q 5/30; H01Q 9/40; H01Q 1/38; H01Q 9/36

(52) U.S. Cl. CPC H01Q 21/24; H01Q 1/38; H01Q 9/36; H01Q 5/30; H01Q 9/40; H01Q 1/523

(57) ABSTRACT

Embodiments disclosed include multi-band monopole planar antennas configured to facilitate radio frequency (RF) isolation in multiple-input multiple-output (MIMO) antenna arrangement. In one aspect, a multi-band monopole planar antenna is provided and configured to generate a slant 45° radiation polarization in the lower frequency band. As a result, sufficient RF isolation may be achieved in the lower frequency band when a plurality of dual-band monopole planar antennas is placed in the MIMO arrangement. In another aspect, the multi-band monopole planar antenna is configured not to support certain unused RF bands, thus facilitating height reduction in the multi-band monopole planar antenna. By configuring the dual-band monopole planar antenna to generate the slant-45 radiation polarization in the lower frequency band, a plurality of the multi-band monopole planar antennas may be placed in close proximity to each other to support MIMO operation without compromising RF performance.

### PRIORITY APPLICATION

This application is a continuation of International Application PCT/IL2015/051061, filed Oct. 29, 2015, which claims the benefit of priority under 35 U.S.C. §119 of U.S. Provisional Application No. 62/074,293, filed on Nov. 3, 2014, the contents of which are relied upon and incorporated herein by reference in their entireties.

### BACKGROUND

The disclosure relates generally to radio frequency (RF) antennas and more particularly to multi-band RF antennas in a multiple-input multiple-output (MIMO) antenna arrangement, which may be used in a distributed antenna system (DAS).

Wireless customers are increasingly demanding multimedia data services, such as streaming videos, on client devices. Concurrently, some wireless customers use their wireless devices in areas that are poorly served by conventional cellular networks, such as inside certain buildings or areas where there is little cellular coverage. One response to the intersection of these two concerns has been the use of DASs. DASs can be particularly useful when deployed inside buildings or other indoor environments where client devices may not otherwise be able to effectively receive RF signals from a wireless service provider. DASs include remote units configured to receive and transmit communications signals to client devices. The remote units can be provided as remote antenna units configured to wirelessly receive and transmit wireless communications signals in the antenna range of the remote antenna units.

As the wireless spectrum becomes more and more crowded, remote antenna units in DASs are increasingly relying on MIMO antennas to achieve higher data rates. One technique that enables the MIMO antennas to provide higher data rates is known as spatial multiplexing. In spatial multiplexing, a high-rate signal is split into multiple streams and provided to multiple antennas for simultaneous transmissions in the same RF band. Because multiple antennas are radiating electromagnetic energy at the same time in the same RF band, this poses a challenge in terms of antenna size and the achievable RF isolation between the multiple antennas. Space separation is a commonly used technique that can provide a desired level of RF isolation between the multiple antennas. In space separation, each of the multiple antennas is placed at a separation distance that is proportionally related to the wavelength of RF used by the multiple antennas. In other words, the separation distance is inversely determined by the radio frequency used by the multiple antennas. In this regard, the lower the radio frequency used by the multiple antennas, the longer the separation distance must be between each of the multiple antennas.

No admission is made that any reference cited herein constitutes prior art. Applicant expressly reserves the right to challenge the accuracy and pertinence of any cited documents.

### SUMMARY

Embodiments disclosed in the detailed description include multi-band monopole planar antennas configured to facilitate improved radio frequency (RF) isolation in multiple-input multiple-output (MIMO) antenna arrangement. The multi-band monopole planar antennas may be configured to support both a lower frequency band(s) and a higher frequency band(s) in a MIMO antenna arrangement to provide the desired RF frequency band coverage. Space separation is a conveniently used technique to provide RF isolation between MIMO antennas. However, it may be difficult to provide sufficient space separation for a lower frequency band when the MIMO antennas are placed in close proximity. In this regard, in one aspect, a multi-band monopole planar antenna is provided and configured to generate a slant 45° (“slant-45”) radiation polarization in the lower frequency band. As a result, sufficient RF isolation may be achieved in the lower frequency band when a plurality of dual-band monopole planar antennas is placed in the MIMO arrangement. In another non-limiting aspect, the multi-band monopole planar antenna is configured not to support certain unused RF bands, thus facilitating height reduction in the multi-band monopole planar antenna. By configuring the dual-band monopole planar antenna to generate the slant-45 radiation polarization in the lower frequency band, a plurality of the multi-band monopole planar antennas may be placed in close proximity to each other to support MIMO operation without compromising RF performance.

One embodiment of the disclosure relates to a dual-band monopole planar antenna. The dual-band monopole planar antenna comprises a semi-elliptical shaped conductive disc having a symmetrical center axis. The dual-band monopole planar antenna also comprises a slot disposed in the semi-elliptical shaped conductive disc along a longitudinal axis substantially perpendicular to the symmetrical center axis to separate the semi-elliptical shaped conductive disc into a first conductive disc section and a second conductive disc section. The dual-band monopole planar antenna also comprises a conductive delay line having a first end feed point and a second end feed point disposed in the slot, wherein the first end feed point is conductively coupled to the first conductive disc section and the second end feed point is conductively coupled to the second conductive disc section. The dual-band monopole planar antenna also comprises a disc feed point disposed in the first conductive disc section, wherein the disc feed point is configured to receive an electrical current from an electrical current source. The conductive delay line is configured to receive the electrical current from the first conductive disc section at the first end feed point and provide the electrical current to the second conductive disc section at the second end feed point. The first conductive disc section is configured to radiate electromagnetic energy on a first RF band with a first radiation polarization in response to receiving the electrical current from the disc feed point. The second conductive disc section is configured to radiate electromagnetic energy on a second RF band having lower frequency than the first RF band with a second radiation polarization different from the first radiation polarization in response to receiving the electrical current from the second end feed point of the conductive delay line.

An additional embodiment of the disclosure relates to a dual-band antenna element. The dual-band antenna element comprises a first dual-band monopole planar antenna mounted on a first substrate. The dual-band antenna element also comprises a second dual-band monopole planar antenna mounted on a second substrate. The first dual-band monopole planar antenna and the second dual-band monopole planar antenna each comprise a respective semi-elliptical shaped conductive disc having a respective symmetrical center axis. The first dual-band monopole planar antenna and the second dual-band monopole planar antenna each also comprise a respective slot disposed in the respective semi-elliptical shaped conductive disc along a respective longitudinal axis substantially perpendicular to the respective symmetrical center axis to separate the respective semi-elliptical shaped conductive disc into a respective first conductive disc section and a respective second conductive disc section. The first dual-band monopole planar antenna and the second dual-band monopole planar antenna each also comprise a respective conductive delay line having a respective first end feed point and a respective second end feed point disposed in the respective slot, wherein the respective first end feed point is conductively coupled to the respective first conductive disc section and the respective second end feed point is conductively coupled to the respective second conductive disc section. The first dual-band monopole planar antenna and the second dual-band monopole planar antenna each also comprise a respective disc feed point disposed in the respective first conductive disc section, wherein the respective disc feed point is configured to receive an electrical current from an electrical current source. The first substrate comprises a first slot opening disposed along the respective symmetrical center axis of the first dual-band monopole planar antenna. The second substrate comprises a second slot opening disposed along the respective symmetrical center axis of the second dual-band monopole planar antenna. The second slot opening of the second substrate receives the first substrate within the first slot opening to dispose the second dual-band monopole planar antenna substantially perpendicular to the first dual-band monopole planar antenna. The first dual-band monopole planar antenna and the second dual-band monopole planar antenna are electrically coupled along an intersection of the first substrate and the second substrate. The respective disc feed point of the first dual-band monopole planar antenna and the respective disc feed point of the second dual-band monopole planar antenna are electrically coupled to provide a common feed point for the dual-band antenna element. The first dual-band monopole planar antenna and the second dual-band monopole planar antenna are configured to each generate a cylinder-shaped slant-45 total electric field when the electrical current is received at the common feed point.

An additional embodiment of the disclosure relates to a MIMO antenna. The MIMO antenna comprises a planar mounting surface. The MIMO antenna also comprises a first dual-band antenna element disposed on the planar mounting surface, wherein the first dual-band antenna element comprises at least one first dual-band monopole planar antenna having a first symmetrical center axis substantially perpendicular to the planar mounting surface and a first longitudinal axis substantially perpendicular to the first symmetrical center axis. The MIMO antenna also comprises a second dual-band antenna element disposed on the planar mounting surface, wherein the second dual-band antenna element comprises at least one second dual-band monopole planar antenna having a second symmetrical center axis substantially perpendicular to the planar mounting surface and a second longitudinal axis substantially perpendicular to the second symmetrical center axis. The second dual-band antenna element is disposed on the planar mounting surface such that the second longitudinal axis is substantially aligned with the first longitudinal axis in the first dual-band antenna element.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The drawings provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary distributed antenna system (DAS) comprising multiple-input multiple-output (MIMO) remote antenna units;

FIG. 2 is a schematic diagram of an exemplary Vivaldi monopole planar antenna;

FIG. 3 is a schematic diagram of an exemplary multi-band monopole planar antenna configured to support a first radio frequency (RF) band with a vertical radiation polarization and a second RF band, which has lower frequency than the first RF band, with an approximate slant 45° (slant-45) radiation polarization to improve RF isolation in the second RF band;

FIG. 4 is a schematic diagram illustrating an exemplary dual-band antenna element comprising two of the multi-band monopole planar antennas of FIG. 3 and configured to provide a cylinder-shaped distribution of a cylinder-shaped slant-45 total electric field around the dual-band antenna element;

FIG. 5 is an exemplary schematic diagram of the dual-band antenna element in FIG. 4 configured to generate the cylinder-shaped approximate slant-45 total electric field of FIG. 4 when energized by an electrical current;

FIG. 6 is an exemplary plot of a top-view radiation pattern and good slant-45 radiation polarization regions generated by the dual-band antenna element in FIG. 5;

FIG. 7 is an exemplary plot of a return loss curve and an RF isolation curve that quantitatively measures the RF performance and the level of RF isolation provided by the dual-band antenna element in FIG. 5;

FIG. 8 is a schematic diagram of an exemplary arrangement of a MIMO antenna comprising a plurality of the dual-band antenna elements in FIG. 5; and

FIG. 9 is a partially schematic cut-away diagram of an exemplary building infrastructure in which the MIMO antenna of FIG. 8 is employed in one or more remote antenna units in a DAS that can be configured with the multi-band monopole planar antennas according to any of the embodiments described herein to provide MIMO-based wireless communications services.

### DETAILED DESCRIPTION

Various embodiments will be further clarified by the following examples.

Embodiments disclosed in the detailed description include multi-band monopole planar antennas configured to facilitate improved radio frequency (RF) isolation in multiple-input multiple-output (MIMO) antenna arrangement. The multi-band monopole planar antennas may be configured to support both a lower frequency band(s) and a higher frequency band(s) in a MIMO antenna arrangement to provide the desired RF frequency band coverage. Space separation is a conveniently used technique to provide RF isolation between MIMO antennas. However, it may be difficult to provide sufficient space separation for a lower frequency band when the MIMO antennas are placed in close proximity. In this regard, in one aspect, a multi-band monopole planar antenna is provided and configured to generate a slant 45° (“slant-45”) radiation polarization in the lower frequency band. As a result, sufficient RF isolation may be achieved in the lower frequency band when a plurality of dual-band monopole planar antennas is placed in the MIMO arrangement. In another non-limiting aspect, the multi-band monopole planar antenna is configured not to support certain unused RF bands, thus facilitating height reduction in the multi-band monopole planar antenna. By configuring the dual-band monopole planar antenna to generate the slant-45 radiation polarization in the lower frequency band, a plurality of the multi-band monopole planar antennas may be placed in close proximity to each other to support MIMO operation without compromising RF performance.

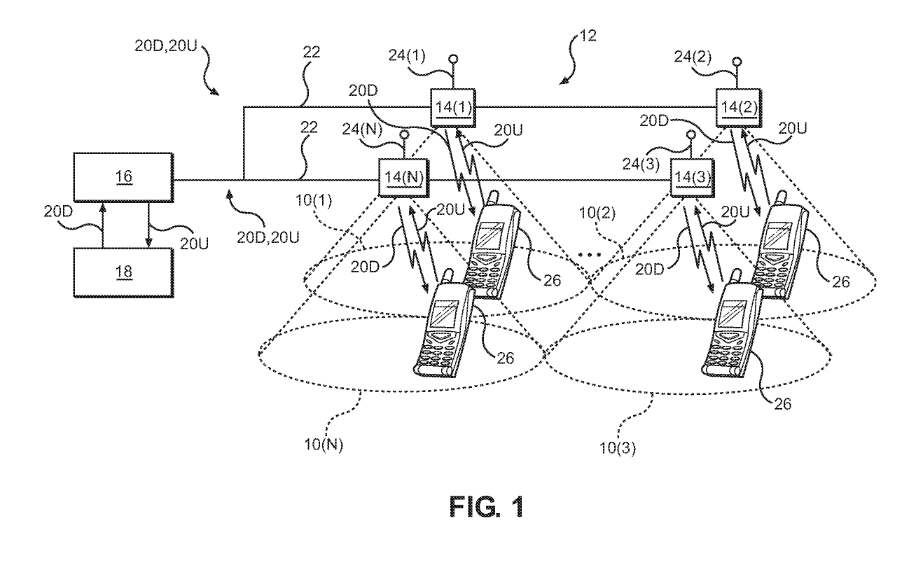

In this regard, FIG. 1 illustrates the distribution of communications services to coverage areas 10(1)-10(N) of a DAS 12, wherein ‘N’ is the number of coverage areas. These communications services can include cellular services, wireless services such as RF identification (RFID) tracking, Wireless Fidelity (Wi-Fi), local area network (LAN), WLAN, and combinations thereof, as examples. The coverage areas 10(1)-10(N) may be remotely located. In this regard, the remote coverage areas 10(1)-10(N) are created by and centered on remote antenna units 14(1)-14(N) connected to a head-end equipment (HEE) 16 (e.g., a head-end controller or head-end unit or central unit). As will be described in more detail below, the DAS 12 is configured to support MIMO communications. In this regard, the remote antenna units 14(1)-14(N), which include one or more multi-band monopole planar antennas that are further discussed later in FIG. 3, may be placed in close proximity to each other to support MIMO operation without compromising RF performance. In this regard, the multi-band monopole planar antennas that are discussed later in FIG. 3 are configured to generate an approximate slant-45 radiation polarization in a lower frequency band. As a result, sufficient RF isolation may be achieved in the lower frequency band when the one or more multi-band monopole planar antennas that are discussed later in FIG. 3 are placed in a MIMO arrangement in the remote antenna units 14(1)-14(N).

With continuing reference to FIG. 1, the HEE 16 may be communicatively coupled to a base transceiver station (BTS) 18. In this regard, the HEE 16 receives downlink RF communications signals 20D from the BTS 18 to be distributed to the remote antenna units 14(1)-14(N). The remote antenna units 14(1)-14(N) are configured to receive the downlink RF communications signals 20D from the HEE 16 over a communications medium 22 to be distributed to the respective remote coverage areas 10(1)-10(N) of the remote antenna units 14(1)-14(N). In a non-limiting example, the communications medium 22 may be a wired communications medium, a wireless communications medium, or an optical fiber-based communications medium. Each remote antenna unit 14(1)-14(N) may include an RF transmitter/receiver (not shown) and at least one respective antenna 24(1)-24(N) operably connected to the RF transmitter/receiver to wirelessly distribute the communications services to client devices 26 within their respective remote coverage areas 10(1)-10(N). The remote antenna units 14(1)-14(N) are also configured to receive uplink RF communications signals 20U from the client devices 26 in their respective remote coverage areas 10(1)-10(N) to be distributed to the BTS 18. The size of a given remote coverage area 10(1)-10(N) is determined by the amount of RF power transmitted by the respective remote antenna units 14(1)-14(N), the receiver sensitivity, antenna gain and the RF environment, as well as by the RF transmitter/receiver sensitivity of the client devices 26. The client devices 26 usually have a fixed maximum RF receiver sensitivity, so that the above-mentioned properties of the remote antenna units 14(1)-14(N) mainly determine the size of their respective remote coverage areas 10(1)-10(N).

In the DAS 12, the downlink RF communications signals 20D may be a long-term evolution (LTE) communications signal transmitted over a large RF spectrum span. In the United States, for example, the RF spectrum allocated by the Federal Communications Commission (FCC) for LTE services ranges from 700 megahertz (MHz) to 2700 MHz. As a result, broadband antennas are often installed in the remote antenna units 14(1)-14(N) to effectively transmit and receive LTE signals over the large RF spectrum span. One type of such broadband antennas is known as a monopole planar antenna, which is discussed next.

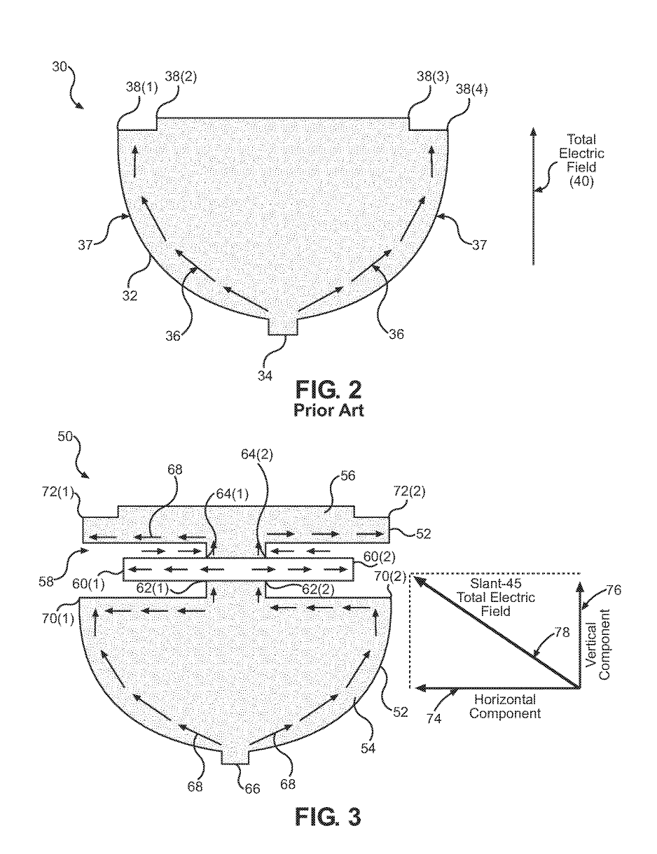

Before discussing examples of multi-band monopole planar antennas configured to provide sufficient isolation in close proximity starting with FIG. 3, discussions of a traditional Vivaldi monopole planar antenna are first provided with reference to FIG. 2.

In this regard, FIG. 2 provides a schematic diagram of an exemplary Vivaldi monopole planar antenna 30. The Vivaldi monopole planar antenna 30 in FIG. 2 is provided in the form of a semi-elliptical shaped conductive disc 32 in this example. The Vivaldi monopole planar antenna 30 may be configured to cover a wide range of continuous RF spectrum. For example, the Vivaldi monopole planar antenna 30 can be configured to cover a continuous RF spectrum ranging from 700 MHz to 2700 MHz. The continuous RF spectrum covered by the Vivaldi monopole planar antenna 30 is proportionally related to an impedance bandwidth of the semi-elliptical shaped conductive disc 32. In this regard, an increase in surface area of the semi-elliptical shaped conductive disc 32 will lead to an increased range of the continuous RF spectrum provided by the Vivaldi monopole planar antenna 30.

With continuing reference to FIG. 2, a disc feed point 34 extends outward from the semi-elliptical shaped conductive disc 32 and is configured to receive an electrical current 36. As illustrated in FIG. 2, when the electrical current 36 travels upward from the disc feed point 34 along the edges 37 of the semi-elliptical shaped conductive disc 32, electromagnetic energy is generated and eventually radiated outward from endpoints 38(1)-38(4). As the electrical current 36 propagates through the semi-elliptical shaped conductive disc 32, a total electric field 40 is generated. The total electric field 40 is a vector field comprising a vertical component and a horizontal component. Strengths of the vertical component and the horizontal component are proportionally related to vertically propagating electrical currents and horizontally propagating electrical currents, respectively. As illustrated in FIG. 2, the electrical current 36 is propagating predominantly in a vertical direction. As a result, the total electric field 40 has a vertical orientation. In other words, the Vivaldi monopole planar antenna 30 radiates electromagnetic energy with a vertical radiation polarization when energized by the electrical current 36.

The vertical radiation polarization produced by the Vivaldi monopole planar antenna 30 makes it difficult to achieve orthogonality among RF signals if a plurality of Vivaldi monopole planar antennas 30 were used in a MIMO antenna arrangement. The issue is especially problematic when the plurality of Vivaldi monopole planar antennas 30 is placed in close proximity and configured to operate in a lower RF band (e.g., 600 MHz or 700 MHz band). In this regard, FIG. 3 is a schematic diagram of an exemplary multi-band monopole planar antenna 50 (which is a dual-band monopole planar antenna in this example) configured to support a first RF band with a vertical radiation polarization and a second RF band, which has lower frequency than the first RF band, with an approximate slant 45° (slant-45) radiation polarization to improve RF isolation in the second RF band.

With reference to FIG. 3, the multi-band monopole planar antenna 50 comprises a semi-elliptical shaped conductive disc 52. The semi-elliptical shaped conductive disc 52 is separated into a first conductive disc section 54 and a second conductive disc section 56 by a slot 58 that is disposed along a longitudinal axis substantially perpendicular to a symmetrical center axis of the semi-elliptical shaped conductive disc 52. As previously discussed in FIG. 2, the semi-elliptical shaped conductive disc 32 enables the Vivaldi monopole planar antenna 30 to cover a continuous RF spectrum ranging from 600 MHz to 2700 MHz. Thus, by separating the semi-elliptical shaped conductive disc 52 into the first conductive disc section 54 and the second conductive disc section 56, the multi-band monopole planar antenna 50 is configured to support two separate RF bands of narrower bandwidth as opposed to one continuous RF band of wider bandwidth. In this regard, the multi-band monopole planar antenna 50 is a modified version of the Vivaldi monopole planar antenna 30 of FIG. 2.

With continuing reference to FIG. 3, the first conductive disc section 54 is configured to radiate electromagnetic energy in a first RF band. The second conductive disc section 56 is configured to radiate electromagnetic energy in a second RF band that has lower frequency than the first RF band. In a non-limiting example, the first RF band ranges from 1700 MHz to 2700 MHz (hereinafter referred to as the “higher RF band”) and the second RF band ranges from 698 MHz to 894 MHz (hereinafter referred to as the “lower RF band”). In the same non-limiting example, the multi-band monopole planar antenna 50 is configured not to support a RF spectrum between 894 MHz and 1700 MHz (hereinafter referred to as the “throw-away RF band”). Because the RF spectrum bandwidth of the multi-band monopole planar antenna 50 is proportionally related to the surface area of the semi-elliptical shaped conductive disc 52, elimination of the throw-away RF band means that physical dimension (e.g., height and/or width) of the multi-band monopole planar antenna 50 may be reduced. As a result, it is possible to fit the multi-band monopole planar antenna 50 into an enclosure with a reduced height. Further, by adjusting respective surface areas (e.g., increasing or decreasing height) of the first conductive disc section 54 and the second conductive disc section 56, it is possible to support other RF band combinations in the multi-band monopole planar antenna 50.

With continuing reference to FIG. 3, a pair of conductive delay lines 60(1) and 60(2) is disposed in the slot 58 between the first conductive disc section 54 and the second conductive disc section 56. The conductive delay line 60(1) has a first end feed point 62(1) conductively coupled to the first conductive disc section 54. The conductive delay line 60(1) has a second end feed point 64(1) conductively coupled to the second conductive disc section 56. The conductive delay line 60(2) has a first end feed point 62(2) conductively coupled to the first conductive disc section 54. The conductive delay line 60(2) has a second end feed point 64(2) conductively coupled to the second conductive disc section 56. According to the exemplary illustration in FIG. 3, each of the conductive delay lines 60(1) and 60(2) is horizontally disposed in the slot 58 to help reduce vertical dimension (e.g., height) of the multi-band monopole planar antenna 50. The conductive delay lines 60(1), 60(2) may be disposed in the slot 58 in any layout. In a non-limiting example, the conductive delay lines 60(1), 60(2) may be disposed between the respective first end feed points 62(1), 62(2) and the respective second end feed points 64(1), 64(2) in a U-shaped layout or a zigzag-shaped layout. In another non-limiting example, the conductive delay lines 60(1), 60(2) may be disposed vertically between the respective first end feed points 62(1), 62(2) and the respective second end feed points 64(1), 64(2). In another non-limiting example, it is possible to dispose any number of conductive delay lines between the first conductive disc section 54 and the second conductive disc section 56. Each of the conductive delay lines 60(1), 60(2) has a respective length measured between the respective first end feed points 62(1), 62(2) and the respective second end feed points 64(1), 64(2). The respective length of the each of the conductive delay lines 60(1), 60(2) may be adjusted to control a lower RF boundary of the lower RF band. For example, increasing or decreasing the respective length of each of the conductive delay lines 60(1), 60(2) may cause the lower RF boundary of the lower RF band to increase or decrease accordingly.

With continuing reference to FIG. 3, a disc feed point 66 extends outward from the first conductive disc section 54. The disc feed point 66 is configured to receive an electrical current 68 from an electrical current source (not shown) to energize the first conductive disc section 54 and the second conductive disc section 56, thus allowing electromagnetic energy to be radiated from the first conductive disc section 54 and the second conductive disc section 56, respectively. As illustrated in FIG. 3, the electrical current 68 received at the disc feed point 66 flows upward along the edges of the first conductive disc section 54, through the conductive delay lines 60(1), 60(2), and then horizontally along the edges of the second conductive disc section 56. As the electrical current 68 propagates through the first conductive disc section 54, a vertical total electric field (not shown), which is similar to the total electric field 40 in FIG. 2, is generated around the first conductive disc section 54. As a result, the first conductive disc section 54 radiates electromagnetic energy from corner points 70(1), 70(2) in the higher RF band with a vertical radiation polarization (first radiation polarization). While some of the electrical current 68 is converted into electromagnetic energy and radiated out by the first conductive disc section 54, a portion of the electrical current 68 continues flowing through the conductive delay lines 60(1), 60(2) to reach the second conductive disc section 56. At the second conductive disc section 56, the electrical current 68 flows horizontally along the edges of the second conductive disc section 56 and eventually turns into electromagnetic energy to be radiated out at end points 72(1), 72(2). The horizontally flowing electrical current 68 produces a horizontal component 74. When the horizontal component 74 conjoins a vertical component 76 produced by the electrical current 68 in the first conductive disc section 54, a slant-45 total electric field 78 is created around the second conductive disc section 56. As such, the electromagnetic energy radiated out of the end points 72(1), 72(2) in the lower RF band has a slant-45 radiation polarization (second radiation polarization). As further discussed later in this specification, the slant-45 radiation polarization in the lower RF band allows the plurality of multi-band monopole planar antennas 50 to be placed in close proximity while maintaining sufficient RF isolation in the lower RF band. For the higher RF band, space separation can provide sufficient RF isolation because of the shorter wavelength of the higher RF band.

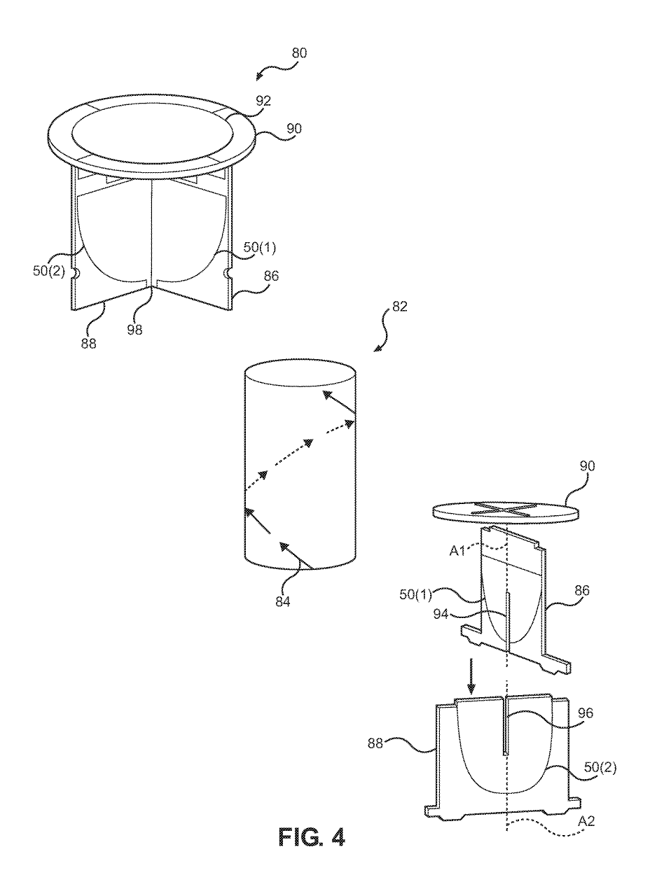

Although the second conductive disc section 56 is able to radiate electromagnetic energy in the lower RF band with the slant-45 radiation polarization, the strongest slant-45 total electric fields 78 are concentrated around the end points 72(1), 72(2). To create a more even distribution of the slant-45 total electric field 78 for the multi-band monopole planar antenna 50, FIG. 4 is a schematic diagram illustrating an exemplary dual-band antenna element 80 comprising two of the multi-band monopole planar antennas 50 of FIG. 3 and configured to provide a cylinder-shaped distribution 82 of a cylinder-shaped slant-45 total electric field 84 around the dual-band antenna element 80. Elements of FIG. 3 are referenced in connection with FIG. 4 and will not be re-described herein.

With reference to FIG. 4, the dual-band antenna element 80 comprises a first substrate 86, a second substrate 88, and a circular-shaped substrate 90. A first multi-band monopole planar antenna 50(1) and a second multi-band monopole planar antenna 50(2) are mounted onto the first substrate 86 and the second substrate 88, respectively. A circular-shaped conductive disc 92 is mounted onto the circular-shaped substrate 90. In a non-limiting example, the first substrate 86, the second substrate 88, and the circular-shaped substrate 90 are circuit boards. The first substrate 86 has a first slot opening 94 disposed along a respective symmetrical center axis A1 of the first multi-band monopole planar antenna 50(1). The second substrate 88 has a second slot opening 96 disposed along a respective symmetrical center axis A2 of the second multi-band monopole planar antenna 50(2). The first substrate 86 is inserted into the second substrate 88 in such a way that the second slot opening 96 of the second substrate 88 receives the first substrate 86 within the first slot opening 94. The first substrate 86 and the second substrate 88 are substantially perpendicular to each other, thus creating a freestanding joint-structure (not shown). Accordingly, the first multi-band monopole planar antenna 50(1) in the first substrate 86 and the second multi-band monopole planar antenna 50(2) in the second substrate 88 are electrically coupled along the intersection of the first substrate 86 and the second substrate 88. The respective disc feed point 66 (not shown) of the first multi-band monopole planar antenna 50(1) and the second multi-band monopole planar antenna 50(2) are electrically coupled to provide a common feed point 98. The common feed point 98 may be coupled to an electrical feeding line (not shown) to receive the electrical current 68 (not shown).

With continuing reference to FIG. 4, the circular-shaped substrate 90 is mounted on top of the freestanding joint-structure (not shown) and electrically coupled to the first multi-band monopole planar antenna 50(1) and the second multi-band monopole planar antenna 50(2). In other words, the circular-shaped substrate 90 is placed on an opposite end from the common feed point 98. By electrically coupling the circular-shaped substrate 90 to the first multi-band monopole planar antenna 50(1) and the second multi-band monopole planar antenna 50(2), the electrical current 68 (not shown) received from the common feed point 98 will eventually flow around the circular-edge of the circular-shaped conductive disc 92. The circularly flowing electrical current 68 facilitates the cylinder-shaped distribution 82 of the cylinder-shaped slant-45 total electric field 84 around the dual-band antenna element 80.

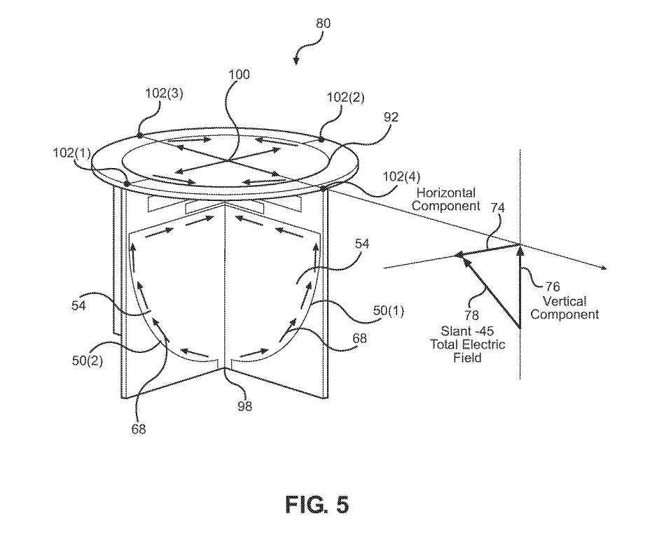

In this regard, FIG. 5 is an exemplary schematic diagram of the dual-band antenna element 80 in FIG. 4 configured to generate the cylinder-shaped slant-45 total electric field 84 (not shown) when energized by the electrical current 68. Common elements between FIGS. 3, 4, and 5 are shown therein with common element numbers, thus will not be re-described herein.

With reference to FIG. 5, the electrical current 68 received from a common feed point 98 flows upward along the respective edges of the first multi-band monopole planar antenna 50(1) and the second multi-band monopole planar antenna 50(2). According to discussions in reference to FIG. 3, the vertical component 76 is produced as a result of the electrical current 68 flowing through the respective first conductive disc section 54 in the first multi-band monopole planar antenna 50(1) and the second multi-band monopole planar antenna 50(2). In the circular-shaped conductive disc 92, the electrical current 68 flows from a center point 100 toward intersection points 102(1)-102(4). The intersection points 102(1), 102(2) are where the circular-shaped conductive disc 92 intersects with the respective end points 72(1), 72(2) (not shown) in the first multi-band monopole planar antenna 50(1). Likewise, the intersection points 102(3), 102(4) are where the circular-shaped conductive disc 92 intersects with the respective end points 72(1), 72(2) (not shown) in the second multi-band monopole planar antenna 50(2). As a result of the electrical current 68 flowing horizontally in the circular-shaped conductive disc 92, the horizontal component 74 is produced. Hence, the horizontal component 74 and the vertical component 76 jointly generate the slant-45 total electric field 78, which is distributed more evenly around the dual-band antenna element 80. Furthermore, the circular-shaped conductive disc 92 helps further reduce the height of the dual-band antenna element 80 so that the dual-band antenna element 80 may be provided in smaller enclosures.

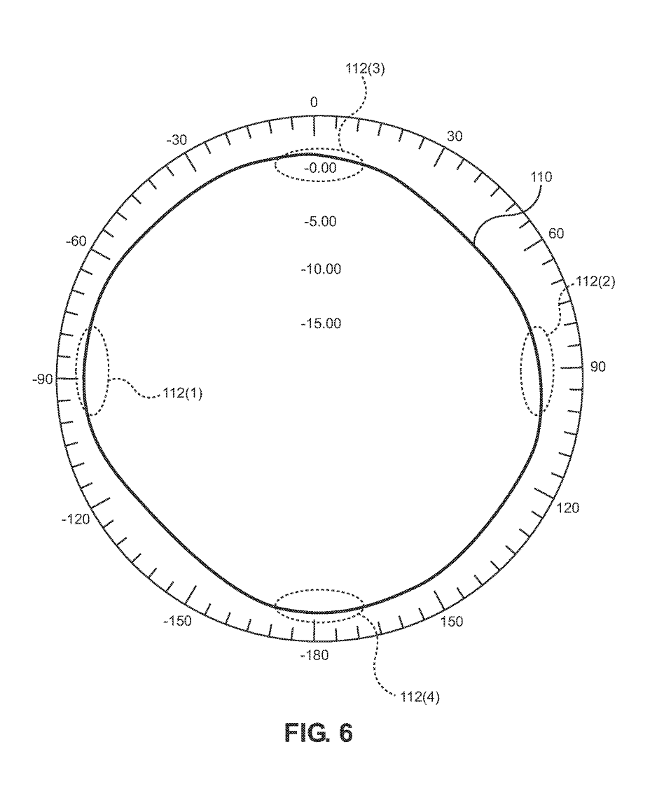

In this regard, FIG. 6 is an exemplary plot of a top-view radiation pattern 110 and good slant-45 radiation polarization regions 112(1)-112(4) generated by the dual-band antenna element 80 in FIG. 5. Elements in FIG. 5 are referenced in connection with FIG. 6 and will not be re-described herein. Not coincidentally, the good slant-45 radiation polarization regions 112(1)-112(4) are strongly correlated to the intersection points 102(1)-102(4) in the dual-band antenna element 80, where the horizontal component 74 and the vertical component 76 are equal (shown in FIG. 5).

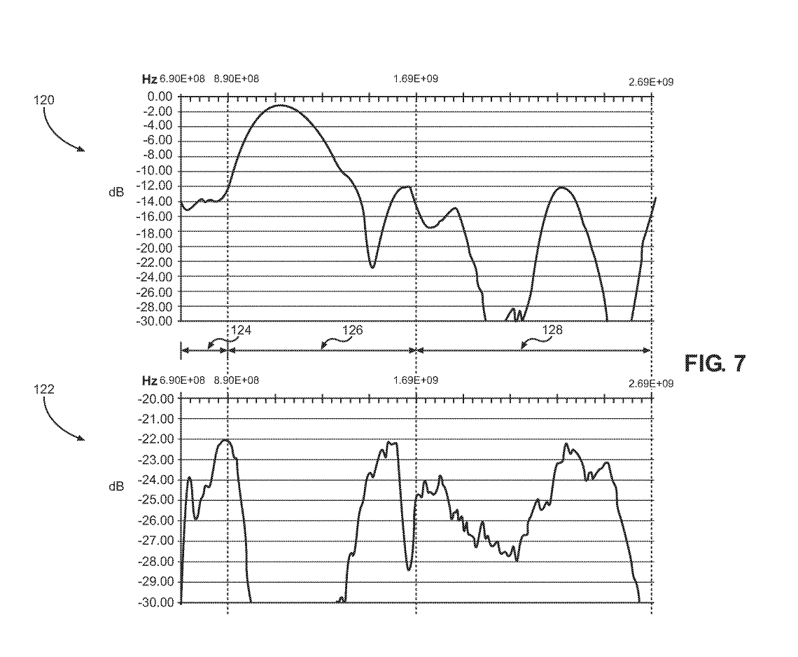

According to the non-limiting example discussed in reference to FIG. 3, the multi-band monopole planar antenna 50 is configured to support the higher RF band ranging from 1700 MHz to 2700 MHz and the lower RF band ranging from 698 MHz to 894 MHz. To provide a quantitative illustration of RF performance of the dual-band antenna element 80 in FIG. 5, FIG. 7 is provided. FIG. 7 is an exemplary plot of a return loss curve 120 and a RF isolation curve 122 that quantitatively measure the RF performance and the level of RF isolation provided by the dual-band antenna element 80 in FIG. 5.

As previously discussed in FIG. 5, when the electrical current 68 received from the common feed point 98 propagates through the dual-band antenna element 80, electromagnetic energy is radiated from the dual-band antenna element 80 in the higher RF band and the lower RF band. It is thus desirable to see a substantial amount of the electrical current 68 being turned into electromagnetic energy and radiated out of the dual-band antenna element 80. By measuring the amount of the electrical current 68 that flows back to the common feed point 98, the return loss curve 120 in FIG. 7 provides a quantitative insight into the RF performance of the dual-band antenna element 80. The return loss curve 120 may be divided into three band segments 124, 126, and 128 to help analyze the RF performance of the dual-band antenna element 80 in the lower RF band (698 MHz-894 MHz), the thrown-away RF band (894 MHz-1700 MHz), and the higher RF band (1700 MHz-2700 MHz), respectively.

With continuing reference to FIG. 7, the highest return losses in the band segments 124, 126, and 128 are approximately −14 decibel (dB), −1 dB, and −12 dB, respectively. In the band segment 126, the −1 dB return loss indicates that nearly all of the electrical current 68 flows back to the common feed point 98 as opposed to being radiated out as the electromagnetic energy in the thrown-away RF band. In contrast, the −14 dB return loss in the band segment 124 and the −12 dB return loss in the band segment 128 indicate that a portion of the electrical current 68 is turned into electromagnetic energy and radiated out from the dual-band antenna element 80 in the lower RF band and the higher RF band, respectively. The return loss curve 120 proves that the dual-band antenna element 80 produces electromagnetic energy radiation in the lower RF band and the higher RF band while having little electromagnetic energy radiation in the thrown-away RF band.

With continuing reference to FIG. 7, the RF isolation curve 122 provides quantitative measurements on the level of RF isolations provided by the dual-band antenna element 80. Clearly from the RF isolation curve 122, the dual-band antenna element 80 is able to provide at least −22 dB RF isolation in both the lower RF band and the higher RF band, thus allowing a plurality of the dual-band antenna elements 80 to be placed in close proximity.

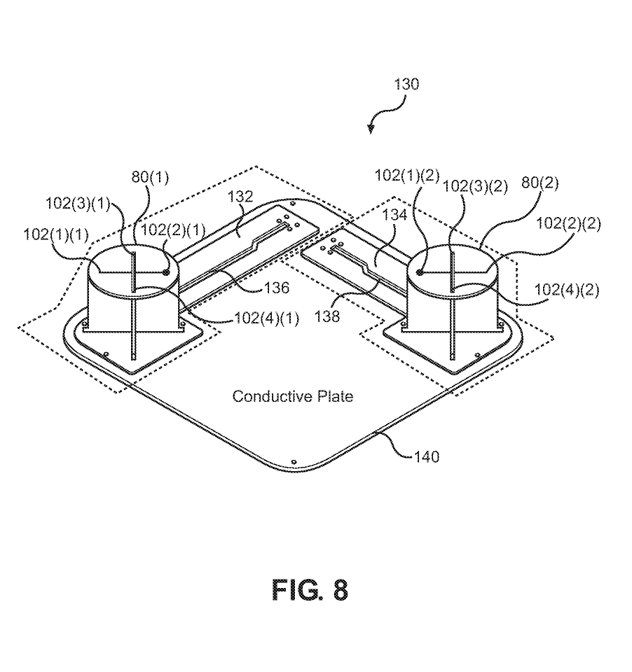

FIG. 8 is a schematic diagram of an exemplary arrangement of a MIMO antenna 130 comprising the plurality of the dual-band antenna elements 80 in FIG. 5. Elements in FIGS. 5 and 6 are referenced in connection with FIG. 8 and will not be re-described herein.

With reference to FIG. 8, the MIMO antenna 130 comprises a first circuit board 132 and a second circuit board 134. The first circuit board 132 comprises a first dual-band antenna element 80(1) electrically coupled to a first electrical feeding line 136 via a first common feed point (not shown). The second circuit board 134 comprises a second dual-band antenna element 80(2) electrically coupled to a second electrical feeding line 138 via a second common feed point (not shown). The first circuit board 132 and the second circuit board 134 are mounted on a planar mounting surface 140. In a non-limiting example, the planar mounting surface 140 is a conductive plate. Like the dual-band antenna element 80 in FIG. 5, the first dual-band antenna element 80(1) has intersection points 102(1)(1), 102(2)(1), 102(3)(1), and 102(4)(1) that produce the good slant-45 radiation polarization regions 112(1)-112(4) (not shown), respectively. Likewise, the second dual-band antenna element 80(2) has intersection points 102(1)(2), 102(2)(2), 102(3)(2), and 102(4)(2) that produce the good slant-45 radiation polarization regions 112(1)-112(4) (not shown), respectively. In a non-limiting example, the first dual-band antenna element 80(1) and the second dual-band antenna element 80(2) are arranged in such a way that one pair of the intersection points 102(1)(1), 102(2)(1) or 102(3)(1), 102(4)(1) in the first dual-band antenna element 80(1) is aligned against another pair of the intersection points 102(1)(2), 102(2)(2) or 102(3)(2), 102(4)(2) in the second dual-band antenna element 80(2). Such alignment allows one of the good slant-45 radiation polarization regions 112(1)-112(4) produced by the first dual-band antenna element 80(1) to be in a linear alignment with one of the good slant-45 radiation polarization regions 112(1)-112(4) produced by the second dual-band antenna element 80(2). As a result of such arrangement, the RF isolation between the first dual-band antenna element 80(1) and the second dual-band antenna element 80(2) is maximized.

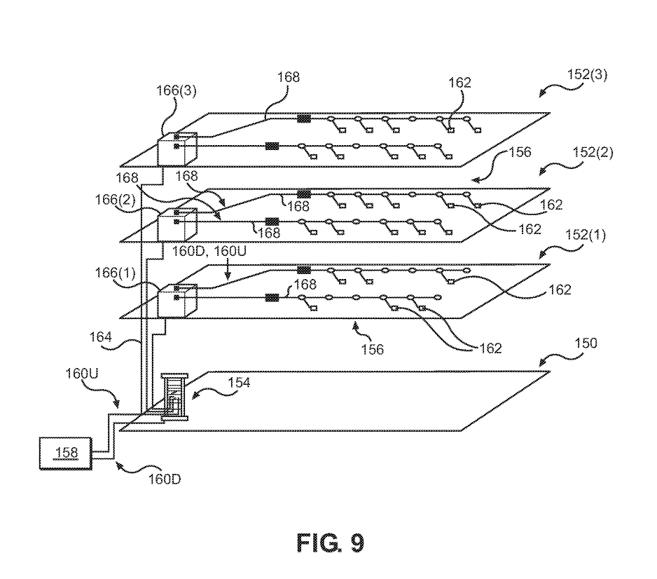

The MIMO antenna 130 of FIG. 8 may be provided in an indoor environment, as illustrated in FIG. 9. FIG. 9 is a partially schematic cut-away diagram of an exemplary building infrastructure in which the MIMO antenna 130 of FIG. 8 is employed in one or more remote antenna units in a DAS that can be configured with the multi-band monopole planar antennas 50 in FIG. 3 according to any of the embodiments described to provide MIMO-based wireless communications services. The building infrastructure 150 in this embodiment includes a first (ground) floor 152(1), a second floor 152(2), and a third floor 152(3). The floors 152(1)-152(3) are serviced by a central unit 154 to provide antenna coverage areas 156 in the building infrastructure 150. The central unit 154 is communicatively coupled to the base station 158 to receive downlink communications signals 160D from the base station 158. The central unit 154 is communicatively coupled to remote antenna units 162 to receive uplink communications signals 160U from the remote antenna units 162. The remote antenna units 162 may employ the MIMO antenna 130 to enable MIMO-based wireless communications services. The downlink and uplink communications signals 160D, 160U communicated between the central unit 154 and the remote antenna units 162 are carried over a riser cable 164. The riser cable 164 may be routed through interconnect units (ICUs) 166(1)-166(3) dedicated to each of the floors 152(1)-152(3) that route the downlink and uplink communications signals 160D, 160U to the remote antenna units 162 and also provide power to the remote antenna units 162 via array cables 168.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A dual-band monopole planar antenna, comprising:
a semi-elliptical shaped conductive disc having a symmetrical center axis;
a slot disposed in the semi-elliptical shaped conductive disc along a longitudinal axis substantially perpendicular to the symmetrical center axis to separate the semi-elliptical shaped conductive disc into a first conductive disc section and a second conductive disc section;
a conductive delay line having a first end feed point and a second end feed point disposed in the slot, wherein the first end feed point is conductively coupled to the first conductive disc section and the second end feed point is conductively coupled to the second conductive disc section; and
a disc feed point disposed in the first conductive disc section, wherein the disc feed point is configured to receive an electrical current from an electrical current source;
wherein the conductive delay line is configured to receive the electrical current from the first conductive disc section at the first end feed point and provide the electrical current to the second conductive disc section at the second end feed point;
wherein the first conductive disc section is configured to radiate electromagnetic energy on a first radio frequency (RF) band with a first radiation polarization in response to receiving the electrical current from the disc feed point; and
wherein the second conductive disc section is configured to radiate electromagnetic energy on a second RF band having lower frequency than the first RF band with a second radiation polarization different from the first radiation polarization in response to receiving the electrical current from the second end feed point of the conductive delay line.

2. The dual-band monopole planar antenna of claim 1, wherein a respective surface area of the first conductive disc section determines an impedance bandwidth for the first RF band.

3. The dual-band monopole planar antenna of claim 2, wherein a respective surface area of the second conductive disc section determines a respective impedance bandwidth for the second RF band.

4. The dual-band monopole planar antenna of claim 3, wherein a respective length of the conductive delay line is measured between the first end feed point and the second end feed point, wherein the respective length of the conductive delay line determines a lower RF boundary of the second RF band.

5. The dual-band monopole planar antenna of claim 4, wherein the conductive delay line is disposed horizontally along the longitudinal axis.

6. The dual-band monopole planar antenna of claim 4, wherein the first radiation polarization is a vertical radiation polarization.

7. The dual-band monopole planar antenna of claim 4, wherein the second radiation polarization is an approximate slant 45° (slant-45) radiation polarization.

8. The dual-band monopole planar antenna of claim 4, wherein:
the first RF band is between approximately 1700 megahertz (MHz) and 2700 MHz; and
the second RF band is between approximately 698 MHz and 894 MHz.

9. A dual-band antenna element, comprising:
a first dual-band monopole planar antenna mounted on a first substrate; and
a second dual-band monopole planar antenna mounted on a second substrate;
wherein the first dual-band monopole planar antenna and the second dual-band monopole planar antenna each comprises:
a respective semi-elliptical shaped conductive disc having a respective symmetrical center axis;
a respective slot disposed in the respective semi-elliptical shaped conductive disc along a respective longitudinal axis substantially perpendicular to the respective symmetrical center axis to separate the respective semi-elliptical shaped conductive disc into a respective first conductive disc section and a respective second conductive disc section;
a respective conductive delay line having a respective first end feed point and a respective second end feed point disposed in the respective slot, wherein the respective first end feed point is conductively coupled to the respective first conductive disc section and the respective second end feed point is conductively coupled to the respective second conductive disc section; and
a respective disc feed point disposed in the respective first conductive disc section, wherein the respective disc feed point is configured to receive an electrical current from an electrical current source;
wherein the first substrate comprises a first slot opening disposed along the respective symmetrical center axis of the first dual-band monopole planar antenna;
wherein the second substrate comprises a second slot opening disposed along the respective symmetrical center axis of the second dual-band monopole planar antenna;
wherein the second slot opening of the second substrate receives the first substrate within the first slot opening to dispose the second dual-band monopole planar antenna substantially perpendicular to the first dual-band monopole planar antenna;
wherein the first dual-band monopole planar antenna and the second dual-band monopole planar antenna are electrically coupled along an intersection of the first substrate and the second substrate;
wherein the respective disc feed point of the first dual-band monopole planar antenna and the respective disc feed point of the second dual-band monopole planar antenna are electrically coupled to provide a common feed point for the dual-band antenna element; and
wherein the first dual-band monopole planar antenna and the second dual-band monopole planar antenna are configured to each generate a cylinder-shaped slant 45° (slant-45) total electric field when the electrical current is received at the common feed point.

10. The dual-band antenna element of claim 9, wherein the first substrate and the second substrate are each comprised of circuit boards.

11. The dual-band antenna element of claim 10, further comprising an electrical feeding line coupled to the common feed point.

12. The dual-band antenna element of claim 11, further comprising a circular-shaped conductive disc electrically coupled to the first dual-band monopole planar antenna and the second dual-band monopole planar antenna on an opposite end from the common feed point, wherein the circular-shaped conductive disc is substantially perpendicular to the respective symmetrical center axis of the first dual-band monopole planar antenna and the second dual-band monopole planar antenna.

13. The dual-band antenna element of claim 9, wherein:
the respective conductive delay line in the first dual-band monopole planar antenna and the second dual-band monopole planar antenna is configured to receive the electrical current from the respective first conductive disc section at the respective first end feed point and provide the electrical current to the respective second conductive disc section at the respective second end feed point;
the respective first conductive disc section in the first dual-band monopole planar antenna and the second dual-band monopole planar antenna is configured to radiate electromagnetic energy on a first radio frequency (RF) band with a vertical radiation polarization in response to receiving the electrical current from the respective disc feed point; and
the respective second conductive disc section in the first dual-band monopole planar antenna and the second dual-band monopole planar antenna is configured to radiate electromagnetic energy on a second RF band lower than the first RF band with a slant-45 radiation polarization in response to receiving the electrical current from the respective second end feed point of the respective conductive delay line.

14. A multiple-input multiple-output (MIMO) antenna, comprising:
a planar mounting surface;
a first dual-band antenna element disposed on the planar mounting surface, wherein the first dual-band antenna element comprises at least one first dual-band monopole planar antenna having a first symmetrical center axis substantially perpendicular to the planar mounting surface and a first longitudinal axis substantially perpendicular to the first symmetrical center axis; and
a second dual-band antenna element disposed on the planar mounting surface, wherein the second dual-band antenna element comprises at least one second dual-band monopole planar antenna having a second symmetrical center axis substantially perpendicular to the planar mounting surface and a second longitudinal axis substantially perpendicular to the second symmetrical center axis;
wherein the second dual-band antenna element is disposed on the planar mounting surface such that the second longitudinal axis is substantially aligned with the first longitudinal axis in the first dual-band antenna element.

15. The MIMO antenna of claim 14, wherein the planar mounting surface is a conductive substrate.

16. The MIMO antenna of claim 15, wherein the at least one first dual-band monopole planar antenna and the at least one second dual-band monopole planar antenna each further comprise:
a respective semi-elliptical shaped conductive disc having a respective symmetrical center axis;
a respective slot disposed in the respective semi-elliptical shaped conductive disc along a respective longitudinal axis substantially perpendicular to the respective symmetrical center axis to separate the respective semi-elliptical shaped conductive disc into a respective first conductive disc section and a respective second conductive disc section;
a respective conductive delay line having a respective first end feed point and a respective second end feed point disposed in the respective slot, wherein the respective first end feed point is conductively coupled to the respective first conductive disc section and the respective second end feed point is conductively coupled to the respective second conductive disc section; and
a respective disc feed point disposed in the respective first conductive disc section, wherein the respective disc feed point is configured to receive an electrical current from an electrical current source.

17. The MIMO antenna according of claim 16, wherein:
the respective conductive delay line in the at least one first dual-band monopole planar antenna and the at least one second dual-band monopole planar antenna is configured to receive the electrical current from the respective first conductive disc section at the respective first end feed point and provide electrical current to the respective second conductive disc section at the respective second end feed point;
the respective first conductive disc section in the at least one first dual-band monopole planar antenna and the at least one second dual-band monopole planar antenna is configured to radiate electromagnetic energy on a first radio frequency (RF) band with a vertical radiation polarization in response to receiving the electrical current from the respective disc feed point; and
the respective second conductive disc section in the at least one first dual-band monopole planar antenna and the at least one second dual-band monopole planar antenna is configured to radiate electromagnetic energy on a second RF band lower than the first RF band with a slant-45 radiation polarization in response to receiving the electrical current from the respective second end feed point of the respective conductive delay line.

18. The MIMO antenna of claim 14, wherein:
the first dual-band antenna element is mounted on a first circuit board; and
the second dual-band antenna element is mounted on a second circuit board electrically decoupled from the first circuit board.

19. The MIMO antenna of claim 18, wherein:
the first circuit board comprises a first electrical feeding line coupled to a first common feed point exposed by the first dual-band antenna element; and
the second circuit board comprises a second electrical feeding line coupled to a second common feed point exposed by the second dual-band antenna element.

20. The MIMO antenna of claim 18, wherein the first dual-band antenna element and the second dual-band antenna element are electrically decoupled from each other.
